(19) United States
(12) Patent Application Publication
(10) Pub. No.: US 2007/0251708 A1
(43) Pub. Date: Nov. 1, 2007

(54) Hammer

(76) Inventor: Michael Stirm, Oberursel (DE)

Correspondence Address: Sr. Group Patent Counsel;Balck & Decker Corporation, Mail Stop TW199, 701 E. Joppa Rd, Towson, MD, 21286, US

(21) Appl. No.: 11/352,475

(22) Filed: Feb. 13, 2006

(30) Foreign Application Priority Data
Feb. 10, 2005 (GB) GB 05 027 21.4

(51) Int. Cl. B25D 16/00

(52) U.S. Cl. 173/95

(57) ABSTRACT

A hammer comprising: a housing 2; a motor mounted within the housing; a tool holder 8 rotatably mounted on the housing 2 for holding a cutting tool; a striker 442 mounted in a freely slideable manner within the housing, for repetitively striking an end of a cutting tool when a cutting tool is held by the tool holder 8, which striker is reciprocatingly driven by the motor, when the motor is activated, via a drive mechanism; wherein the drive mechanism comprises: a pivoting drive arm 457 pivotally mounted within the housing 2 at one end and which is drivingly connected to the striker 442; a pivotal drive mechanism connected to the pivoting drive arm 457 which converts a rotary movement generated by the motor to an oscillating pivoting movement of the pivoting drive arm 457 about its pivot point; characterised in that the pivotal drive mechanism comprises a series of wedge shaped ramps 460 which are formed around the circumference of a rotatable shaft 424 wherein the pivoting drive arm 457 is connected via a part which abuts against the rotatable shaft 424 so that, upon rotation of the shaft, the part abuting against the shaft 424 rides over the wedge shaped ramps 460 causing the pivoting drive arm 457 to pivotally oscillate.

### FIELD OF THE INVENTION

The present invention relates to powered hammers, to powered rotary hammers, and to power drills having a hammer action.

### BACKGROUND OF THE INVENTION

EP0145070 describes a hammer which comprises (referring to FIG. 7) a ram 26 (using the same reference numbers as EP0145070) which is slideably mounted with the main housing of the hammer and which can be reciprocatingly driven via a pivotal arm 32 which is pivotally mounted within the housing of one end about a pivot. The pivotal arm 32 is pivotally driven by the motor via a pivotal drive mechanism which converts the rotary movement of the motor into an oscillating pivotal movement of the arm 32. The ram 26 strikes a tool shaft 1 which in turn imparts the impacts to the end of a cutting tool.

The problem with the design of hammer mechanism disclosed in EP0145070 is that the pivotal drive mechanism is complex. The present invention provides a simpler construction.

DE4121279, GB2295347 and U.S. Pat. No. 5,337,835 are also relevant pieces of prior art.

### BRIEF SUMMARY OF THE INVENTION

According to a first aspect of the present invention there is provided a hammer comprising:

a housing;

a motor mounted within the housing;

a tool holder rotatably mounted on the housing for holding a cutting tool;

a striker mounted in a freely slideable manner within the housing, for repetitively striking an end of a cutting tool when a cutting tool is held by the tool holder, which striker is reciprocatingly driven by the motor, when the motor is activated, via a drive mechanism;

wherein the drive mechanism comprises:

a pivoting drive arm pivotally mounted within the housing at one end and which is drivingly connected to the striker;

a pivotal drive mechanism connected to the pivoting drive arm which converts a rotary movement generated by the motor to a pivoting movement of the pivoting drive arm about its pivot point;

characterised in that the pivotal drive mechanism comprises a series of wedge shaped ramps which are formed around the circumference of a rotatable shaft wherein the pivoting drive arm is connected via a part which abuts against the rotatable shaft so that, upon rotation of the shaft, the part abuting against the shaft rides over the wedge shaped ramps.

According to a second aspect of the present invention, there is provided a hammer comprising:

a housing;

a motor mounted within the housing;

a tool holder rotatably mounted on the housing for holding a cutting tool;

a striker mounted in a freely slideable manner within the housing, for repetitively striking an end of a cutting tool when a cutting tool is held by the tool holder, which striker is reciprocatingly driven by the motor, when the motor is activated, via a drive mechanism;

wherein the drive mechanism comprises:

a pivotal drive mechanism connected to the striker by at least one spring which converts a rotary movement generated by the motor to an oscillating pivoting movement of the striker;

a first end of the spring is connected to the pivotal drive mechanism, the other second end being fixedly connected to the striker;

characterised in that the at least one spring surrounds the striker.

Such constructions can be utilised both in rotary hammers which can perform a drilling function, chiselling function or a combination of the two, and in hammers which can perform a chiselling function only.

### BRIEF DESCRIPTION OF THE DRAWINGS

An embodiment of the present invention will now be described with reference to the accompanying drawings of which:

FIG. 1 shows a perspective view of a percussion drill;

FIG. 2A is a side view of a hammer mechanism of the embodiment of the present invention; and

FIG. 2B is a vertical cross section view of the end of the spindle of the hammer mechanism of the present invention in the direction of Arrows H of FIG. 2A.

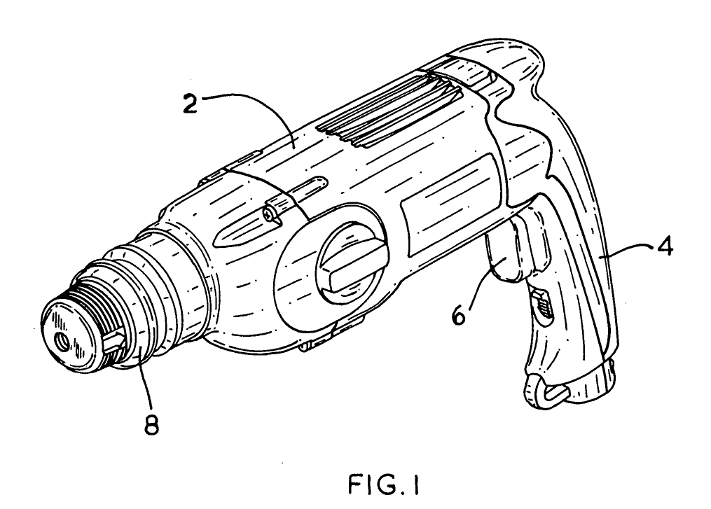

### DETAILED DESCRIPTION OF THE INVENTION

A hammer drill comprises a housing 2 in which is mounted a motor (not shown). A handle 4 is attached to the rear of the housing which can be activated using a trigger switch 6. A tool holder is mounted on the front of the housing 2. The tool holder 8 holds a cutting tool (not shown) such as a drill bit. The motor reciprocatingly drives a ram which in repetitively impacts the end of a cutting tool, via a beat piece, when located within the tool holder in well known manner.

The present invention concerns the mechanism by which the rotary drive generated by the motor is converted into a reciprocating movement of the ram within a hammer. Four embodiments of the present invention will now be described.

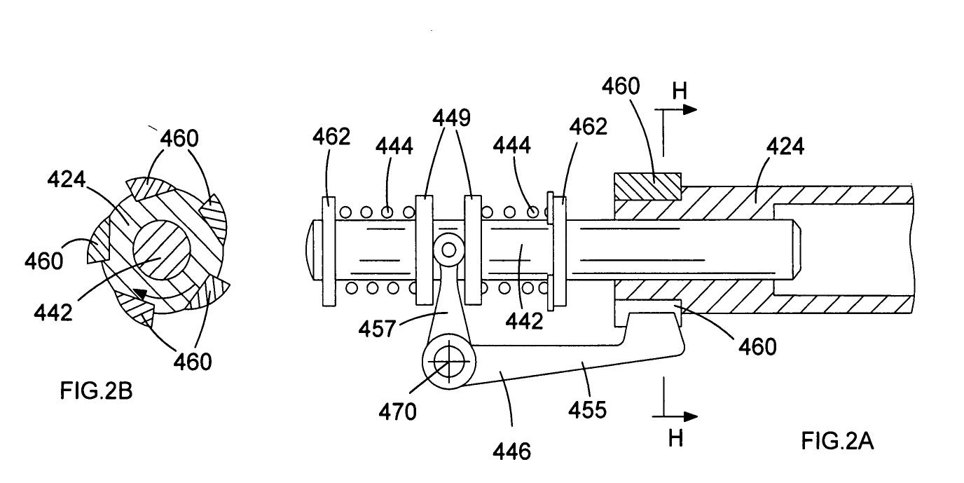

FIGS. 2A and 2B show the hammer mechanism. The hammer action is generated by rotation of the spindle 424 supporting a chuck and a drill bit (not shown). The external periphery of the spindle 424 at a rear end thereof is provided with wedge shaped ramps 460 around its circumference (as best seen in FIG. 2B). An L-shaped lever member 446 is pivotally mounted about a point 470 and has a first arm 455 urged by means of a torsion spring (not shown) into engagement with the external periphery of the rear end of the spindle 424 and a second arm engages a support 449 engaging respective flanges 462 on a ram 442 via respective springs 444. The ram is slidably supported within the support 449 and spindle 424, the ram being able to freely axially slide within the support 449 and spindle 424. When the spindle 424 is rotated in a clockwise direction, as shown in FIG. 4B, it causes vertical oscillation of the distal end of the first arm 455 of lever member 446, and as a result of which, horizontal oscillation of the support 449 (due to the pivoting motion of the L-shaped lever member 446). This in turn causes the ram 442 to oscillate horizontally due to being connected to the support 449 via the springs 444.

Alternatively, the torsion spring can be omitted. In such a design, the first arm 455 is urged into engagement with external periphery of the rear and of the spindle 424 by springs 444. This is achieved by ensuring that the location of the flanges 462 and the strength and length of the springs 444 are such that the support comes to rest at a position on the ram 442 to cause the first arm 445 to engage the spindle 424. During using, the construction of the system is such that the arm 445 engage the spindle 424 and rides over the ramps 460.

1. A hammer comprising:
a housing 2;
a motor mounted within the housing;
a tool holder 8 rotatably mounted on the housing 2 for holding a cutting tool;
a striker 442 mounted in a freely slideable manner within the housing, for repetitively striking an end of a cutting tool when a cutting tool is held by the tool holder 8, which striker is reciprocatingly driven by the motor, when the motor is activated, via a drive mechanism; wherein the drive mechanism comprises:
a pivoting drive arm 457 pivotally mounted within the housing 2 at one end and which is drivingly connected to the striker 442;
a pivotal drive mechanism connected to the pivoting drive arm 457 which converts a rotary movement generated by the motor to an oscillating pivoting movement of the pivoting drive arm 457 about its pivot point;
characterised in that the pivotal drive mechanism comprises a series of wedge shaped ramps 460 which are formed around the circumference of a rotatable shaft 424 wherein the pivoting drive arm 457 is connected via a part which abuts against the rotatable shaft 424 so that, upon rotation of the shaft, the part abuting against the shaft 424 rides over the wedge shaped ramps 460 causing the pivoting drive arm 457 to pivotally oscillate.

2. A hammer as claimed in claim 1 wherein the shaft 424 is a spindle.

3. A hammer as claimed in any one of the previous claims wherein the reciprocating drive mechanism is connected to the pivoting drive arm 457 via an engagement arm 455 which connects to the pivoting drive arm 457 at the pivot point.

4. A hammer as claimed in claim 3 wherein the part which abuts against the rotatable shaft 242 is mounted on the engagement arm 455.

5. A hammer as claimed in any of the previous claims wherein at least one spring 444 is further provided which connects between the pivoting drive arm 457 and the striker 442, one end of which is fixedly connected to an end, remote from the pivot point, of the pivoting drive arm 457, the other end being fixedly connected to the striker 442.

6. A hammer as claimed in claim 5 wherein the spring 444 is helical.

7. A hammer as claimed in either of claims 5 or 6 wherein there are two springs 444.

8. A hammer as claimed in claim 7 wherein the springs 444 are co-axial.

9. A hammer as claimed in any one of claims 5 to 8 wherein the at least one spring 444 surrounds the striker 442.

10. A hammer comprising:
a housing 2;
a motor mounted within the housing;
a tool holder 8 rotatably mounted on the housing 2 for holding a cutting tool;
a striker 442 mounted in a freely slideable manner within the housing, for repetitively striking an end of a cutting tool when a cutting tool is held by the tool holder 8, which striker is reciprocatingly driven by the motor, when the motor is activated, via a drive mechanism; wherein the drive mechanism comprises:
a pivotal drive mechanism connected to the striker by at least one spring which converts a rotary movement generated by the motor to an oscillating pivoting movement of the striker;
a first end of the spring 444 is connected to the pivotal drive mechanism, the other second end being fixedly connected to the striker 442;
characterised in that the at least one spring 444 surrounds the striker.

11. A hammer as claimed in claim 10 wherein there is further provided a pivoting drive arm 437 pivotally mounted within the housing 2 at one end, the pivotal drive mechanism connecting to the spring 444 via the pivoting drive arm 457, the pivotal drive mechanism driving the pivoting drive arm 457 in a reciprocating manner, the first end of the spring being fixedly connected to the pivoting drive arm.

12. A hammer as claimed in either of claims 10 or 11 wherein there are two springs 444 which surround the striker.

13. A hammer as claimed in claim 12 wherein the two springs are co-axial.

14. A hammer as claimed in claims 10 to 13 wherein the at least one spring 444 is helical.

15. A hammer as claimed in claim 14 wherein the longitudinal axis of the at least one spring 444 is parallel to or co-axial with that of the striker 442.
